(19) United States
(12) Patent Application Publication
(10) Pub. No.: US 2013/0304270 A1
(43) Pub. Date: Nov. 14, 2013

(54) NETWORKED DIFFERENTIAL PROTECTION METHOD FOR A DISTRIBUTION NETWORK BASED ON OVERHAULING OF TERMINAL EQUIPMENT

(71) Applicants: XJ GROUP CORPORATION, Xuchang (CN); STATE GRID CORPORATION OF CHINA, Beijing (CN)

(72) Inventors: Yunlong XU, Beijing (CN); Jianmin XUE, Beijing (CN); Shuilan WU, Beijing (CN); Yu HAN, Beijing (CN); Dingguo WANG, Beijing (CN); Yang LIU, Beijing (CN)

(73) Assignees: STATE GRID CORPORATION OF CHINA, Beijing (CN); XJ GROUP CORPORATION, Xuchang (CN)

(21) Appl. No.: 13/651,421

(22) Filed: Oct. 14, 2012

(30) Foreign Application Priority Data
May 11, 2012 (CN) 201210145759.X

(51) Int. Cl. G05F 5/00

(52) U.S. Cl. 700/292

(57) ABSTRACT

The present invention relates to a networked differential protection method for a distribution network based on overhauling of terminal equipment. The present invention comprises the steps of detecting in real time an operation state of a terminal equipment, and reconstructing a differential logic when there is a terminal equipment under an overhaul state so as to bring it into a state in which an overhaul mode and an operation mode are in parallel; for the operation mode in the state in which an overhaul mode and an operation mode are in parallel, only calculating data of all nodes in normal operation in an electrical element by a differential protection for the electrical element, while excluding data under the overhaul state in the electrical element from taking part in calculation. With the method of the present invention, the operation switch may be reliably switched off and failures may be isolated when they appear during an experiment of a scheduled test. The experiment of the scheduled test may be completed, and the correctness of the electrical topological configuration and the terminal equipment network configuration of the networked differential protection device may be automatically verified.

### CROSS-REFERENCE TO RELATED APPLICATION

This application claims the priority benefit of Chinese application no. 201210145759.X, filed on May 11, 2012. The entirety of the above-mentioned patent application is hereby incorporated by reference herein and made a part of specification.

### BACKGROUND OF THE INVENTION

1. Field of the Invention

The present invention relates to a networked differential protection method for a distribution network based on overhauling of the terminal equipment, which belongs to the field of automatic protection for relays in electrical power engineering.

2. Background of the Invention

Quick motions of the relay protection device and rapid removal of failures in the electrical equipment are one of the most effective measures for increasing transient stabilities of electrical systems, alleviating damages to the equipment and lowering failure loss. Thus, whole-line quick-action protections are usually provided in the domestic power grids with voltage levels of 220 kV and above as the main protections. In power distribution systems with middle or low voltage levels, because of factors such as technologies, investments and people's conventional customs, three-steps or two-steps current protections and current and voltage interlock protections with time match, which have been used for decades, are usually employed. These protections have the problems such as low selectivity of failure removal, low reliability of trip due to failures, and long failure process time.

With the increasing needs for electrical power and constant changes in characteristics of power load, power grid structures in electrical systems, especially the power grid structures of distribution networks in cities and large and medium industrial and mining enterprises, have experienced great adjustments, bringing increasingly smaller power supply radius of distribution stations, correspondingly shorter lengths of distribution lines and increasingly larger transmitted load amount. The above changes in distribution network and the access of distributed power supplies bring many new problems to relay protection, and conventional relay protections with time match have exposed some shortcomings and cannot satisfy system requirements. Thus, it is necessary to realize a whole-line quick-action protection, which is allowed in term of technology conditions and does not involve large amount of investments and devices.

With the implementation and promotion of IEC 61850 standard, it is possible to apply a smart networked differential protection for a distribution network. The networked differential protection for a distribution network is a networked differential protection system for a distribution network consisting of a networked differential protection device and a smart distribution terminal. By providing the whole-line quick-action protection, i.e., the differential protection, it is possible to realize quick location and isolation of distribution network failures and fast power restoration for non-failure regions so as to practically increase the reliabilities of power supply in the distribution network.

The protection scope of the networked differential protection for a distribution network is no longer individual electrical elements in conventional differential protections but a larger power distribution area, thus requiring to test and verify the correctness of electrical topological configuration and terminal network configuration. When certain node equipment is under an overhaul, the differential protection cannot be exited simply. It should be ensured that there is no false action in differential protection and that the differential protection does not refuse to act when other nodes in related electrical elements of the nodes under an overhaul, which were in normal operation, have failures.

### BRIEF SUMMARY OF THE INVENTION

The object of the present invention is to ensure that, when a node equipment in the distribution network is under an overhaul, there is no false action in the differential protection and that the differential protection does not refuse to act when other nodes in related electrical elements of the nodes under overhaul, which were in normal operation, have failures.

To address the above technical problem, the present invention provides a networked differential protection method for a distribution network based on overhauling of terminal equipment, which includes the steps of:

1) detecting in real time whether a terminal is under an overhaul state;

2) if it is detected that there is a node under the overhaul state in the terminal equipment, automatically performing differential logic reconstruction to set the differential logic as a state in which an overhaul mode and an operation mode are in parallel;

3) for a differential protection of an electrical element in the operation mode in the state in which an overhaul mode and an operation mode are in parallel, only calculating data of all nodes in normal operation in the electrical element, and excluding data under the overhaul state in the electrical element from taking part in calculation.

Performing the differential protection on the terminal equipment under the overhaul mode in which the overhaul mode and the operation mode are in parallel is realized by applying a failure simulation value to a node under overhaul via a testing device.

A differential protection action command under the overhaul mode sent by a relay protection device has an overhaul bit.

When receiving the differential protection action command with the overhaul bit, the terminal equipment under the overhaul state switches off an overhaul switch; and when receiving the differential protection action command with the overhaul bit, the terminal equipment under the operation state does not switch off a switch in normal operation and sends feedback information regarding inconsistence of trip overhaul to a relay protection device.

The advantageous effects of the present invention reside in that: the present invention detects in real time whether a terminal equipment is under an overhaul state and makes it in a state in which an overhaul mode and an operation mode are in parallel by reconstructing the differential logic; for a differential protection of an electrical element in the operation mode in the state in which an overhaul mode and an operation mode are in parallel, only data of all nodes in normal operation in the electrical element is calculated, while data under the overhaul state in the electrical element are excluding from taking part in calculation. By employing the protection method of the present invention, operation switch may be reliably switched off and failures may be isolated when there are failures in the distribution network during an experiment of a scheduled test.

### BRIEF DESCRIPTION OF THE DRAWINGS

FIG. 1 is a schematic diagram of a typical line connection of a distribution network;

FIG. 2 is a schematic diagram of a line connection of a networked differential protection system;

FIG. 3 is a schematic diagram of overhaul strategies of the networked differential protection according to an embodiment of the present invention.

### DETAILED DESCRIPTION OF THE INVENTION

The present invention is described in detail below in conjunction with drawings

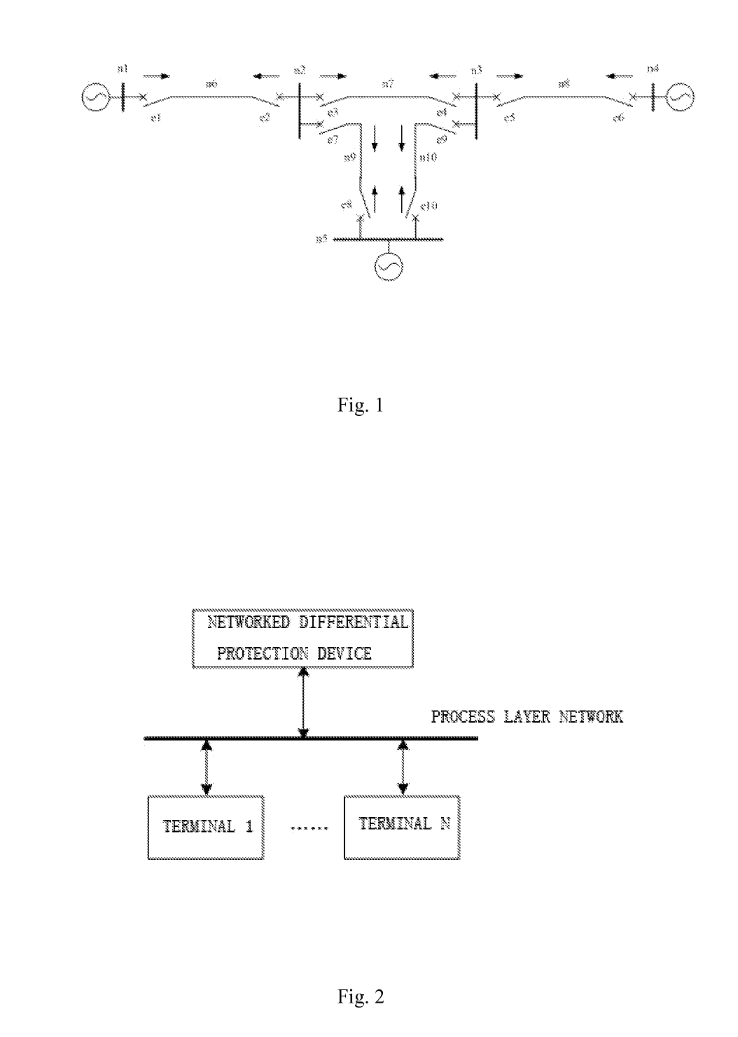

As shown in FIG. 1, there is a plurality of nodes in a distribution network. As shown in FIG. 2, for every node, a terminal samples data and transmits it to a networked differential protection device via a process layer network according to IEC 61850 standard.

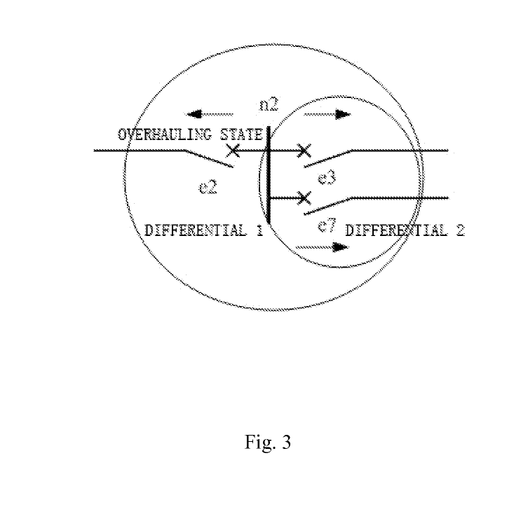

FIG. 3 is a schematic diagram of the differential logic reconstruction of the present invention. The specific process follows.

1. The networked differential protection device detects in real time whether a terminal is under an overhaul state, and performs a differential protection on the terminal equipment using a differential protection equation if the terminal is not under an overhaul state.

2. When detecting that there is a node (e2) under the overhaul state, the networked differential protection device automatically completes the differential logic reconstruction with an operation mode (differential 2 in FIG. 3) and an overhaul mode (differential 1 in FIG. 3) being in parallel.

3. Under the operation mode in which the operation mode and the overhaul mode are in parallel, the node (e2) under the overhaul state in the electrical element no longer takes part in calculation, while only protection data of all the nodes (e3, e7) in normal operation are calculated. When there is a failure, the differential protection can act correctly, i.e., only switch off all the operation switches in the elements in failure. Under the overhaul mode in which the operation mode and the overhaul mode are in parallel, the networked differential protection device calculates the data of all related nodes (e2, e3, e7) (the differential flow between e3 and e7 is 0 theoretically), the terminal applies a failure simulation value to the node (e2) under overhaul via a testing device. The differential equation acts when the differential flow satisfies the action equation.

In order to effectively distinguish from the GOOSE trip command under a normal operation mode, the GOOSE trip command under the overhaul mode has an overhaul bit. When a terminal equipment under the overhaul state receives a GOOSE trip command with the overhaul bit, it switches off the overhaul switch. When a terminal equipment under the operation mode receives the GOOSE trip command with the overhaul bit, it does not switch off a switch in a normal operation and sends feedback information regarding the inconsistence of GOOSE trip overhaul to the networked differential protection device. The networked differential protection device automatically verifies the correctness of the electrical topological configuration and the terminal equipment network configuration of the networked differential protection device according to the position of the overhaul switch and the information regarding the inconsistence of the GOOSE trip overhaul fed by the running terminal.

By employing the present invention, the experiment of the scheduled test of the networked differential protection can be addressed, and the correctness of the electrical topology configuration and terminal equipment network configuration of the networked differential protection device can be verified. Besides, it is ensured that the operation switch may be reliably switched off and failures may be isolated when there are failures during the experiment of the scheduled test.

What is claimed is:

1. A networked differential protection method for a distribution network based on overhauling of terminal equipment, characterized in that the method comprises the steps of:
1) detecting in real time whether a terminal is under an overhaul state;
2) if it is detected that there is a node under the overhaul state in the terminal equipment, automatically performing differential logic reconstruction to set the differential logic as a state in which an overhaul mode and an operation mode are in parallel;
3) for a differential protection of an electrical element in the operation mode in the state in which an overhaul mode and an operation mode are in parallel, only calculating data of all nodes in normal operation in the electrical element, and excluding data under the overhaul state in the electrical element from taking part in calculation.

2. The method according to claim 1, characterized in that, performing the differential protection on the terminal equipment under the overhaul mode in which the overhaul mode and the operation mode are in parallel is realized by applying a failure simulation value to a node under overhaul via a testing device.

3. The method according to claim 1, characterized in that, a differential protection action command under the overhaul mode sent by a relay protection device has an overhaul bit.

4. The method according to claim 3, characterized in that, when receiving the differential protection action command with the overhaul bit, the terminal equipment under the overhaul state switches off an overhaul switch; and when receiving the differential protection action command with the overhaul bit, the terminal equipment under the operation state does not switch off a switch in normal operation and sends feedback information regarding inconsistence of trip overhaul to a relay protection device.
